(19) United States
(12) Patent Application Publication
(10) Pub. No.: US 2010/0250875 A1
(43) Pub. Date: Sep. 30, 2010

(54) EEPROM EMULATION USING FLASH MEMORY

(75) Inventors: KAFAI LEUNG, AUSTIN, TX (US); WILLIAM DURBIN, AUSTIN, TX (US)

Correspondence Address: HOWISON & ARNOTT, L.L.P, P.O. BOX 741715, DALLAS, TX, 75374-1715, US

(73) Assignee: SILICON LABORATORIES INC., AUSTIN, TX (US)

(21) Appl. No.: 12/411,209

(22) Filed: Mar. 25, 2009

(51) Int. Cl. G06F 12/00

(52) U.S. Cl. 711/155; 711/E12.001

(57) ABSTRACT

A device is provided wherein a traditional EEPROM device is emulated by using two or more pages of block-erasable memory and mapping each traditional EEPROM write instruction to an incremented active data sector in a first page of the block-erasable memory while a second page of the block-erasable memory is being partially or fully erased. Then, when the first page of block-erasable memory has had its plurality of data sectors written, changing the active page to the second block-erasable memory and mapping traditional EEPROM writes to incremented data sectors therein while the previously written block-erasable memory is being partially or fully erased.

This application is related to U.S. patent application Ser. No. 11/695,014, filed on Mar. 21, 2007 and titled “METHOD AND APPARATUS FOR EMULATING REWRITABLE MEMORY WITH NON-REWRITABLE MEMORY IN AN MCU” (Atty. Dkt. No. CYGL-28,249), which is incorporated herein by reference.

### TECHNICAL FIELD

Embodiments of the present invention relate to Electrically Erasable Programmable Read Only Memory (EEPROM) architecture and functionality, and more particularly, to an Emulated Electrically Programmable Read Only Memory (EEEPROM) device architecture that emulates a EEPROM by incorporating block-erasable memory, such as flash memory, into the EEEPROM architecture.

### BACKGROUND

Electrically Erasable Programmable Read Only Memory or EEPROM (also written E2PROM) is a type of non-volatile memory used with microcontrollers, microprocessors, computers and other electronic devices to store relatively small amounts of data that need to be saved when power is removed from the device. Some examples of data that may need to be stored in an EEPROM when a device is not powered or looses power are device configuration data, device calibration data, device password or security related data, to name only a few. Generally, traditional EEPROM has two basic types of interfaces. The two basic types of interfaces are serial bus or parallel bus interfaces. How a traditional EEPROM operates depends mainly on the type of electrical interface it has with peripheral circuits.

Many traditional EEPROM devices have a serial interface for reading and writing data. The most common serial interface types are SPI, I²C, Microwire, UNI/O and 1-Wire. These interfaces require between one and four control signals for operation and may result in an EEPROM memory device package having 8 or less pins.

A traditional serial EEPROM typically operates in three phases: (i) the Op-Code Phase, (ii) the Address Phase, and (iii) the Data Phase. The Op-Code Phase is usually the first 8-bits (e.g., the first byte) of input into the serial input of the traditional EEPROM device, which is then followed by 8 to 24 bits of addressing (depending on the depth of the EEPROM memory space) and then the data to be read or written.

A traditional EEPROM device typically has its own set of OP-Code instructions that map to different EEPROM functions. In some circumstances the OP-Code instructions are placed in Special Function Registers (SFRs) of a microcontroller or microprocessor to thereby control the different functions of traditional EEPROM circuitry. Some examples of common instructions for a traditional serial on-chip or peripheral EEPROM device are (i) Write Enable (WREN), which is used to enable or disable writes to the EEPROM; (ii) Read Status REGISTER (RDSR) and Write Status Register (WRSR); (iii) Read Data (READ), which is generally used to instruct a read from a sector of the EEPROM; Write Data (WRITE), which is used to instruct a write to a sector of the EEPROM; and Sector Erase (SERASE), which is used to instruct that a sector or single byte of memory of the EEPROM be erased or placed in an all high or all low state.

Traditional parallel EEPROM devices typically have an 8-bit data bus and an address bus that is wide enough to address the complete EEPROM memory. If the traditional parallel EEPROM is a peripheral device it may have chip select and write protect inputs. Some microcontrollers have integrated or on-chip traditional parallel EEPROM circuitry. The operation of a traditional serial EEPROM device is a bit more complex and slower than that of a traditional parallel EEPROM device.

Usually, when large amounts of data are stored in non-volatile memory, it is more economical to use a specific type of EEPROM, called flash memory, rather than traditional EEPROM memory.

Flash memory is considered a later form of and a specific type of EEPROM. In the memory industry, there is a convention to reserve the term EEPROM to byte-wise writeable, readable, and erasable memories (i.e., traditional EEPROM) rather than for the block-wise erasable (and in certain instances block-wise writeable and readable) flash memories. Also, traditional EEPROM takes more die area than flash memory for the same memory space capacity because each cell of traditional EEPROM usually needs a Read and a Write & Erase transistor. Flash memory requires less room than traditional EEPROM because the Erase circuits are shared by large blocks of memory cells. A typically block of flash memory cells that share an erase circuit may be 512×8 memory cells in size.

Flash memory, like traditional EEPROM is a type of non-volatile memory that can be electrically erased and reprogrammed. Flash memory costs less to manufacture than traditional EEPROM and takes less physical die space. Flash memory offers fast read access times that are comparable to traditional EEPROM, but present day flash memory is not typically as fast a volatile DRAM memory. One limitation of flash memory is that, although it can read or program a single byte or word at a time in a random address/access fashion, it must erase a block at a time. In other words, flash memory (for example, NOR flash memory) offers random-access read and programming operations, but cannot offer arbitrary random-access rewrite or erase operations. Furthermore, it takes much more time to erase a block of flash memory and to write a byte or word to a memory location therein than it takes to erase and/or rewrite a single byte or word to a memory location of traditional EEPROM It is mainly because of the block-erase limitations that flash memory is not used in traditional EEPROM circuits and devices. As such, the lower manufacturing cost and smaller die size advantages of flash memory technology have not been utilized in the EEPROM device market. What is needed is a EEPROM device that utilizes the lower cost and smaller size advantages of block-erasable flash memory technology without being limited by flash memory's block erase limitations.

### SUMMARY

Embodiments of an exemplary EEEPROM take advantage of block-erasable memory's and flash memory's lower manufacturing cost, smaller size as well as the block-erase functionality to provide an economical device that emulates traditional EEPROM devices while providing additional useful functionality. Embodiments that comprise block-erasable memory, such as flash memory, have at least two pages of block-erasable memory that are configured in a ping-pong storage structure. The ping-pong storage structure may operate such that while a first page of the block-erasable memory is being written and/or read, a second page of the block-erasable memory is being either fully or partially erased. The second page of block-erasable memory is being either fully or partially erased to prepare the second page of memory to become the active page of memory when the present active page (the first page of memory) is full. The two block-erasable pages of memory ping-pong in this manner such that while one page is being written or read, the other page is being erased and vis-a-vis. Embodiments may be addressed, written and read by peripheral circuits as if it is a traditional EEPROM device, but in fact, an exemplary embodiment is physically and operationally different therefrom.

One embodiment comprises control logic circuitry, which may include mapping circuitry or decode circuitry, a first block-erasable memory page and a second block-erasable memory page. A process or method of writing data to an exemplary embodiment may comprise first writing a predetermined number of data bytes to a first address space and then mapping and writing, by the control logic circuitry, the contents of the first address space to an active data sector in the first block-erasable memory page. The active data sector is one of a plurality of data sectors in the first block-erasable memory page. The active data sector may also be a next unwritten data sector of the plurality of data sectors in the first block-erasable memory page. Each data sector of the plurality of data sectors comprises at least the same number of data bytes as the predetermined number of data bytes. This process or method of writing may be repeated for each new data that is written to the first address space until a last unwritten data sector of the first block-erasable memory page is written. Meanwhile, while the data sectors of the first block-erasable memory page are being written, the data sectors of the second block-erasable memory page are being block-erased such that by the time the first block-erasable memory page has had all of its data sectors written, the second block-erasable memory page will be fully erased and available such that its data sectors can be written while the first block-erasable memory page is being block-erased.

Furthermore, embodiments may receive a request such that the active data sector of either the first or second block-erasable memory page will be read and provided to a peripheral circuit. In order to do so, it is determined, by the control logic circuitry, which one of the first block-erasable memory or the second block-erasable memory has the data sector that is the active data sector. The active data sector is generally the data sector that was last one to be mapped to and written by the control logic circuitry.

In some embodiments, a tag sector or dedicated memory register (volatile or non-volatile) is provided to store the active page status of the block-erasable memory pages and the data sector status of the data sectors in the active page. The tag sector or dedicated memory register provides, at least, page and data sector status information to the control logic circuitry to aid in the determination of which page of memory is the valid or active page and which data sector of the valid or active page is the active data sector that contains active data. The control logic circuitry may also utilize and update the tag sector or dedicated memory register to keep track of the active or valid page and the active data sector on the active or valid page. When the control logic circuitry maps to and writes to an active page, the active data sector is advanced from the address of the active data sector to the address of a next data sector (which becomes the “new” active data sector). Meanwhile, the tag sector or memory register is updated to indicate the change of the address of the active data sector such that when an exemplary EEEPROM is read, the newly written active data sector is read therefrom.

In yet another embodiment, a method of reading data from and writing data to a block-erasable memory that comprises a plurality of pages and a control logic circuit is provided. In this exemplary embodiment, the method of reading data from the block-erasable memory comprises receiving, by the control logic circuit, a read request from, for example, a peripheral circuit or a microcontroller circuit. After receiving the read request, the control logic circuit determines which page of a plurality of memory pages is an active page. The control logic circuit further determines which sector of a plurality of sectors on the active page is the active sector. Active data can then be read from the active sector of the active page and provided to a memory register such that the active data in the memory register is output data. The output data within the memory register may be determined, via a checksum process, to be valid data and then made available to a peripheral circuit. With respect to writing data to a block-erasable memory, the method or process of writing the data may comprise the control logic circuit for first determining which page of the plurality of pages of memory is the active page. The control logic circuit will then determine which data sector of the active page is the active data sector. If the control logic circuit determines that the active data sector is not the last data sector of the active page, then the active data sector's address is incremented to be equal to the next data sector's address. Each page of block-erasable memory includes a predetermined number of data sectors. When the active data sector is incremented to the next data sector, the next data sector is then designated as the “new” active data sector. Conversely, if the active data sector is the last data sector of the active page, then the active page is changed to a next page of the plurality of pages and the active data sector designation is changed to be the first data sector of the next page. (Of course, the next page is then designation as the active page). Meanwhile, if the control logic circuit determines that the first data sector of the active page is not the active data sector then the control logic circuit instructs a block-erasable memory page, which is not the active page, to be at least partially erased such that, by the time the last data sector of the active page is designated the active data sector, the data sectors of the next page will be fully erased before the designation of the active page is changed to the next page. After all the mapping and or decoding of which page is the active page and which data sector is the active data sector, then register data can be written to the active data sector of the active page.

Embodiments take advantage of the non-volatile memory attributes of flash or block-erasable memory while eliminating or minimizing some disadvantages of traditional EEPROM circuitry as will be more readily understood from reading the complete specification of the invention and the claims while reviewing the various figures.

### BRIEF DESCRIPTION OF THE DRAWINGS

For a more complete understanding of various objects and characteristics of the various embodiments of the invention, as well as methods of operation and functions of related elements of structure, and the combination of parts and economics of manufacture, will be become apparent upon consideration of the following description and appended claims with reference to the accompanying drawings. All of which form a part of this specification wherein like reference numerals designate corresponding parts or elements in the various figures and wherein:

FIG. 1 is a functional block diagram illustrating a microcontroller incorporating an exemplary Emulated Electrically Erasable Programmable Read Only Memory (EEEPROM);

FIG. 2 is a functional block diagram of an exemplary EEEPROM;

FIG. 3 is a another functional block diagram of an exemplary EEEPROM;

FIG. 4 is flow diagram illustrating a data download (Read) process from an exemplary EEEPROM;

FIG. 5 is a flow diagram illustrating data upload (Write) process to an exemplary EEEPROM with a full Erase function; and

FIG. 6 is a flow diagram illustrating data upload (Write) process to an exemplary EEEPROM with a partial Erase function; and

### DETAILED DESCRIPTION

Referring now to the drawings, wherein like reference numbers are used herein to designate like elements throughout. The various views and embodiments of exemplary block-erasable memories being incorporated, for example, into an Emulated EEPROM (EEEPROM), or other memory device that takes advantage of the economic advantages of block-erasable memory and incorporates block-erasable memory to emulate random or arbitrary memory read, write and erase functions are illustrated and described. Furthermore, other possible embodiments are described herein. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

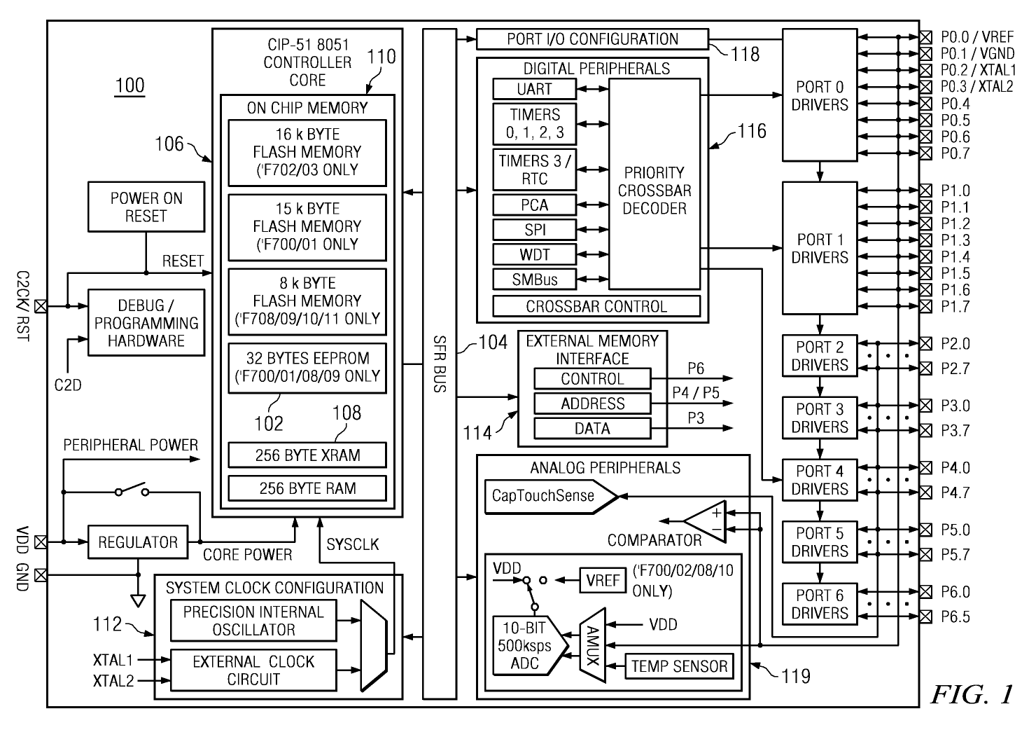

Referring now to the drawings, and more particularly to FIG. 1, a functional block diagram of and exemplary microprocessor or microcontroller 100 (hereinafter microprocessor and microcontroller shall be referred to as an “MCU”) incorporating an exemplary on-chip EEEPROM 102 is illustrated. In one embodiment, an exemplary MCU 100 may be a fully integrated mixed signal, system-on-a chip microcontroller. In other embodiments, the MCU 100 may not be a fully integrated system-on-a-chip style microcontroller, yet still incorporate EEEPROM functionality using an embodiment of the herein described EEEPROM 102. This can either be on-chip memory or peripheral. Referring still to FIG. 1, a Special Function Register Bus (SFR Bus) 104 provides communication of Special Function Register (SFR) contents. The SFRs (not specifically shown) may be found in predetermined memory locations of, for example, a direct-access data memory 108 of a micro controller core 106. In general, SFRs contain flags or specifically formatted bytes of data that enable a control and data exchange with an MCU's on-chip resources (sub-systems) and various peripheral devices or circuitry. On-chip resources generally means and may include one or more of specialized circuits, but not limited to, EEEPROM, on-chip memory 110 (that incorporates or does not incorporate EEPROM or EEEPROM), system clock circuitry 112, external memory control circuitry 114, various digital peripheral circuitry 116, input/output (I/O) port configuration circuitry 118 and analog circuitry 119. Peripheral circuitry may include substantially any circuit or device that is not an on-chip resource including, but not limited to, temperature, pressure or other sensing circuitry; control circuitry; optical data I/O circuitry; mathematical or co-processing circuitry; or various types of memory devices and systems to name only a small fraction of the possibilities. In an exemplary embodiment, the controller core 106 duplicates the SFRs found in a typical 8051 microprocessor implementation or, for that matter, the SFRs used in substantially any other microprocessor or micro controller while also implementing additional SFRs needed to configure and access various on-chip resources and subsystem circuits specific to an exemplary MCU 100. As such, any exemplary MCU 100 incorporating an exemplary EEEPROM 102 may utilize its typical or necessary SFRs (and Op-Code) so that the MCU 100 is compatible with its usual instruction set and also have additional SFRs allowing the additional functionality provided with the incorporation of an exemplary EEEPROM 102 therein.

Referring further to FIG. 1, the MCU 100 is a single chip processing unit of the type described in U.S. Pat. No. 7,171,542, issued Jan. 30, 2007 and entitled “FIELD PROGRAMMABLE MIXED-SIGNAL CIRCUIT,” which is incorporated herein by reference. The processing core, as noted herein above, is configured to utilize a typical 8051 processing structure. It is an instruction based processor and requires interface to on-chip memory and possibly off-chip memory. However, the on-chip memory is comprised of flash memory 120, on-chip random access memory (RAM) 122, XRAM memory 124 and the EEEPROM 102. The memory occupies part of the memory space of the processing core 106. The configuration data, etc., in addition to the program data, is contained within the flash memory. Thus, under normal operating conditions, the 8051 processing core 106 operates to fetch instructions from the flash memory 120 in accordance with the normal process of the 8051 core. However, there are certain situations where the user is provided the ability to program or write to non-volatile memory of the EEPROM type. The reason that EEPROM memory is desirable over flash based memory is that flash based memory typically requires a longer time to erase and it is a block erase configuration whereas an EEPROM memory can be smaller and the erase can be selective for smaller memory. Thus, a rewrite of a particular address associated with a EEPROM can be more desirable than writing to a flash memory location that was previously written to. Typically, a flash memory is considered to be non-volatile storage of information containing program information (instructions, etc.) that is loaded from an external location, whereas an EEPROM memory can be utilized locally to store certain temporary configuration data, calibration data, etc.

The external interface to the system is provided via the C2 data port 126 which is a single wire communication bus with a clock input on input 128.

The timing for the chip is provided by the clock block 112 which is comprised of both an external crystal controlled clock 130 and a precision internal oscillator 132, the output of which is selected by a multiplexer 134, depending on the method of operation. Additionally, although not shown, it is possible to include real time clock functionality associated therewith and also provide a low frequency clock. The clock operation is described in U.S. Pat. No. 7,395,447, issued Jul. 1, 2008, entitled “PRECISION OSCILLATOR FOR AN ASYNCHRONOUS TRANSMISSION SYSTEM,” (Atty. Dkt. No. CYGL-26,116), which is incorporated herein by reference in its entirety. The output of the multiplexer 134 provides the system clock, SYSCLK, which is utilized to provide timing to the overall system.

In operation, the 8051 core 106, during execution of its program, may require access to various special function registers (SFR) via the SFR bus 104. The SFR bus 104 is an internal bus that allows interface to various peripheral blocks. The digital peripherals 116, for example, allow various functional elements such as a UART 136, a serial port interface (SPI) 138, etc., to be interfaced via a crossbar 140 to the various digital outputs and analog outputs. These typically allow different functionalities to be mapped to the digital output via port drivers 142. The analog peripheral block 119 allows analog inputs to be sampled by, for example, a capacitor touch sense block 144. The operation of this analog peripheral is described in U.S. patent application Ser. No. 12/146,352 filed Jun. 25, 2008, and entitled “SYSTEM AND METHOD FOR MONITORING A CAPACITIVE SENSOR ARRAY,” (Atty. Dkt. No. CYGL-29,022) which is incorporated herein by reference in its entirety. Additionally, via an analog line 146, other of the ports associated with the port drivers 142 can be designated as analog inputs and the value thereon can be sampled with an analog-to-digital converter (ADC) 148.

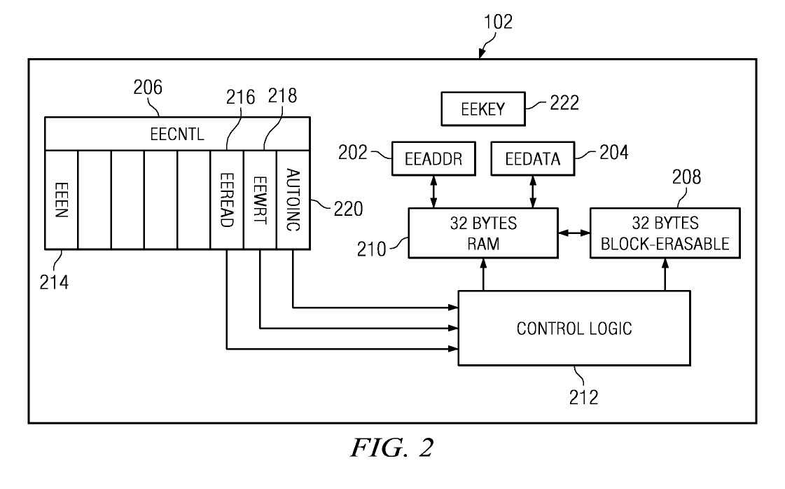

Referring now to FIG. 2, a block diagram of an exemplary EEEPROM 102 is provided. An exemplary EEEPROM 102 may emulate a traditional EEPROM device or circuit. In FIG. 2, 32 bytes of EEPROM are being emulated by the exemplary EEEPROM 102. An exemplary EEEPROM 102 is controlled via various SFR registers including EEPROM address (EEADDR) 202, EEPROM data (EEDATA) 204, and EEPROM control (EECNTL) 206 registers. A predetermined amount of block-erasable, non-volatile RAM 208 is used in an exemplary device such that at any time a 32 byte portion of the block-erasable, non-volatile RAM 208 is being used to emulate a traditional EEPROM. In an exemplary EEEPROM device 102 the portion of the block-erasable, non-volatile RAM 208 that operates as a 32-byte EEPROM is two pages of 512×8 bytes of non-volatile, block erasable memory. As will be explained in more detail, it is understood that any byte size of traditional EEPROM may be emulated using two or more pages of block-erasable, non-volatile memory. The block erasable, non-volatile memory 208 is byte programmable and readable, and emulates a byte rewrite or erase functionality such that it operates, from an MCU's perspective, as a traditional EEPROM having, for example, only 32 byte s of EEPROM data space. The block-erasable, non-volatile memory 208 may comprise at least two flash memory pages or other block-erasable memory that is volatile with electrical power back up or non-volatile.

An exemplary EEEPROM 102 may mirror each active non-volatile byte of block-erasable memory with an equal number of volatile data space bytes depicted as RAM 210. In the exemplary EEEPROM module 102, both the volatile RAM 210 or memory register 210 and an active memory space of the block-erasable memory 208 are 32 byte s long. The volatile RAM 210 data space can be accessed indirectly using SFRs by addressing the RAM 210 with, for example, EEADDR 202 and EEDATA 204. EEADR 202 comprises the EEPROM byte address while EEDATA 204 comprises EEPROM byte data. The EEADDR and EEDATA SFR registers are functionally similar to SFR registers that may be associated with a traditional EEPROM.

An exemplary EEEPROM module 102 emulates traditional EEPROM Reads and Writes by setting the control logic circuitry 212 using the EECNTL 206 SFR. For example, the EECNTL 206 SFR has its EEPROM Enable Bit (EEEN) 214 set prior to any Read or Write of the RAM 210. Thirty-two (32) bytes of register RAM 210 can be accessed indirectly using the SFRs EEADDR 202 and EEDATA 204. When the EEEN 214 bit is set and thereby enables appropriate logic signals to be provided to the control logic circuit 212. The control logic circuit then allows a single byte of the 32 byte s of RAM 210 to be written to, for example, a peripheral circuit. To write to a byte of the RAM 210, write the address of the byte to EADDR 202 and then write the value to be written to EEDATA 204.

Conversely, in exemplary embodiments, the same 32 byte s of RAM 210 can be read indirectly and individually using the SFRs EEADDR 202 and EEDATA 204. When the EEEN 214 bit is set to enable appropriate logic signals to be provided to the control logic circuit 212, a single byte of the 32 byte s of RAM 210 may also be the read. To read a byte from RAM 210, write the address of the byte to be read to EEADDR. The value stored in that address can then be read from EEDATA.

Still referring to FIG. 2, when the Auto Increment (AUTOINC) 220 bit is set in the EECNTL 206 SFR, then the address of EEADDR 218 will be incremented by one after each Write to EEDATA 204 and each Read from EEDATA 204. When Auto Increment is set to be enabled and address in EEADDR reaches the top address of the dedicated volatile RAM space 210, then the next write-to or read-from EEDATA 204 will cause the address in EEADDR to wrap along the RAM 210 address boundary, which will set the address to “0” (or the bottom address of the dedicated volatile register RAM space 210).

Still using the emulation of a 32-byte traditional EEPROM memory space example, access to the block-erasable memory 208 that is basically emulating the memory space of a traditional EEPROM is done using the dedicated 32 byte s of volatile RAM 210. Writes from the register RAM 210 to the block-erasable memory 208 can be performed only when such Writes have been enabled. In an embodiment, Writes from RAM 210 to the block-erasable memory 208 are enabled when a predetermined sequence of one or more bytes are written to a SFR called EEPROM Key (EEKEY) 222. After the control logic 212 is provided appropriate logic signals indicating that the proper predetermined bytes were written to EEKEY 222, then the contents of an active sector of the block-erasable memory 208 can be uploaded to the RAM 210 by setting the EEPROM Read bit 216 of the EECNTL 206 SFR. Furthermore, after the EEPROM control logic 212 is provided appropriate logic signals, indicating that the proper predetermined bytes were written to EEKEY 222, contents of the RAM 210 can be downloaded to the active sector of the block-erasable memory 208 by setting the EEPROM Write bit 218 of the EECNTL 206 SFR.

In an exemplary embodiment of the EEEPROM 102, the RAM 210 can only be downloaded to the block-erasable memory 208 after firmware or software writes a predetermined value or sequence of one or more bytes to the EEKEY 222 SFR. In one embodiment, Writes from the RAM 210 to the block-erasable memory 208 are enabled when a first EEPROM code key of 0×55 Hex byte is written to EEKEY 222. And, then a second EEPROM code key of 0×AA Hex byte is written to EEKEY 222. The proper sequence of EEPROM code key bytes written to the EEKEY are decoded by the EEPROM control logic 212, which enables a single write from the RAM 210 to the block-erasable memory 208. After the single Write is executed, the control logic circuit 212 locks or disables any additional Writes to the block-erasable memory 208 until the correct two byte sequence of EEPROM code keys have been provided to EEKEY 222 again. In other embodiments, such protection key codes may not be required.

In some embodiments, the exemplary flash or block-erasable memory 208 can be a dedicated block of memory. In yet other embodiments, the flash or block-erasable memory 208 may be part of a larger block of block-erasable memory that also comprises memory space for program memory. In embodiments wherein the flash or block-erasable memory 208 is part of a larger block of block-erasable memory, the MCU will not be able to fetch instructions while the EEEPROM control logic is writing or reading from the block-erasable memory.

In some embodiments, the protection state an exemplary EEEPROM (i.e., whether a write from the RAM 210 to the block-erasable memory 208 is locked or allowed) can be determined by reading a predetermined bit of the EEKEY 222 SFR. Reading the protection state of an exemplary EEEPROM can be done at any time without affecting the emulated EEPROM's protection state. Furthermore, if the predetermined sequence for unlocking a Write to the block-erasable memory of the EEEPROM is entered incorrectly, or if the write from the RAM 210 to the emulated EEPROM 208 is signaled with the EEWRT bit without the proper unlock sequence being first provided, then all the following instructions to write to the block-erasable memory 208, with or without a proper unlock sequence, will not be allowed until the EEEPROM 102 encounters a power-on reset.

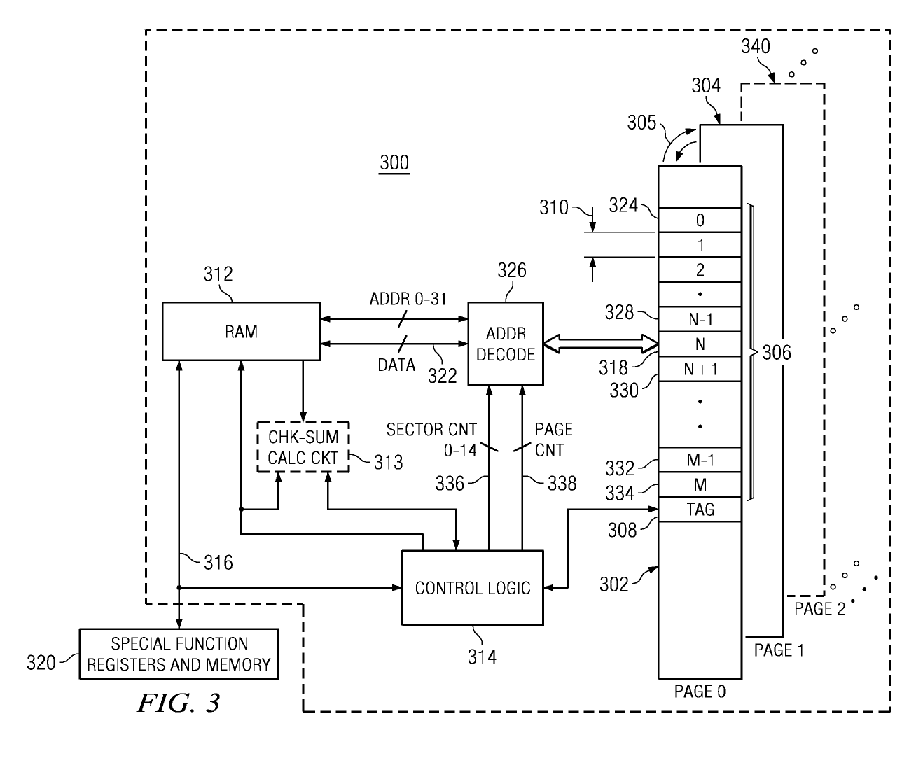

Referring now to FIG. 3, a block diagram of another embodiment of an exemplary EEEPROM 300 is depicted. An exemplary EEEPROM architecture includes two or more pages of flash memory or other type of block-erasable memory. Two exemplary pages of flash memory are depicted as page0 302 and page1 304. Each page of flash memory 302, 304 is a 512 byte flash memory page. In various embodiments each page of flash may be, for example, 32, 64, 128, 256, 512, 1024, 2048 bytes or a larger number of bytes or words long. The two flash memory pages 302, 304 are connected in a Ping-Pong storage structure 305 such that page0 302 and page1 304 are alternately loaded and erased. In other words, while page0 302 is being written, page1 304 is being erased. And alternately, while page1 304 is being written, page0 is being erased.

Each flash memory page has M memory sectors 306 and in some embodiments one tag sector 308. Each memory sector 310 has a predetermined number of bytes. For example, in an exemplary embodiment wherein there are 512 bytes of flash memory per page, M=15 and the predetermined number of bytes in each memory sector 310 is thirty-two (32). Thus, in this example, each flash page 302, 304 has 15 data sectors plus one tag sector 308. Each sector 310 is 32 byte s long by 1 byte wide (32×1 bytes). Each of the plurality of data sectors 306 is used in turn for non-volatile storage of 32-bytes of active data. Each data sector, when active or valid, emulates the program (Write) and Read functionality of a traditional EEPROM. The tag sector 308 is used to store page status, sector usage record, and a checksum of each sector in the page. The page status portion of the tag sector 308 indicates whether the flash page (i.e., page0 302 or page1 304) is the active (or valid) page. The sector usage record indicates which sectors of the active page have been used and which sector in the active page is the active sector. Continuing with the example, the tag sector 308 may use byte 0 and byte 1 to indicate whether page0 302 or page1 304 (or any other page of block-erasable memory) are the valid or active page. Tag sector bytes 2 through 15 may be used to indicate which data sector is the active data sector by taking advantage of the fact that, in flash memory, each cell has a default or erased state that is logically equivalent to a binary “1” value and the fact that a memory location, which has been erased to “1111” can be rewritten as long as the new value's “0” bits are a super set of the over-written values. For example, if an erased flash memory byte starts as “1111”, then it can be written as “1110.” Successive writes to that byte may be “1100”, “1000” and finally “0000”. If 16 bits (or two bytes) are used, this technique can be used to indicate which of the 15 data sectors 306 is active. Tag sector bytes 15 and 16 may contain the validity of the flash memory page for read and/or write. Tag sector bytes 17 through 30 may contain the check sum for data sectors 0 through 14. And, tag sector byte 31 may be left empty or used for another pertinent status.

Still referring to FIG. 3 and continuing with an example of an exemplary EEEPROM 300 having two 512-byte flash memory pages with M=15 data sectors 306 and each memory sector being 32-bytes long. The RAM 312 acts as a register file and EEEPROM Read or Write to an SFR. The RAM 312 is the same size as each flash memory data sector 310. Thus, in our example RAM 312 is 32 byte s long. Data in the RAM 312 register file can be uploaded (written) to a flash page's sector for nonvolatile storage per a proper control logic 314 request. A data bus 316 provides Op-codes, addresses, and data to the RAM 312 register and the control logic 314. The Op-codes, addresses and data may be provided by and placed on the data bus 316 by an MCU's SFRs, peripheral memory, a peripheral circuit or any number of sources 320. As such an MCU or other device can only directly access the RAM 312 for an emulated EEPROM read or write.

In some embodiments, when power is going down to an exemplary EEEPROM device 300, the data contained in the RAM 312 can be uploaded to an active sector of a flash memory page 302, 304 when a power-down EEEPROM storage feature is enabled via the control logic 314. Furthermore, data in an active sector, for example sector N, of an active flash page 302, 304 can be downloaded (read) to the RAM 312 register file per a proper request received by the control logic circuit 314 from data bus 316. For example, upon power-up an MCU may provide the necessary Op-code command(s) from one or more SFR registers 320 such that the active flash memory page and sector contents is downloaded (read) to the RAM 312 register file (as a function of reading the tag portions of the two flash pages) so that the most recently stored data (active data) that was stored in an active data sector of an active page of the exemplary EEEPROM 300 is restored for the MCU access as if it was accessing the address of the memory space of a traditional EEPROM.

After a sector N 318 of a page (for example page0 302) of flash memory is uploaded (written) with data from the RAM 312, then that sector N 318 becomes the active sector of the active page and effectively emulates a traditional EEPROM for downloads (reads) of an exemplary EEEPROM 300.

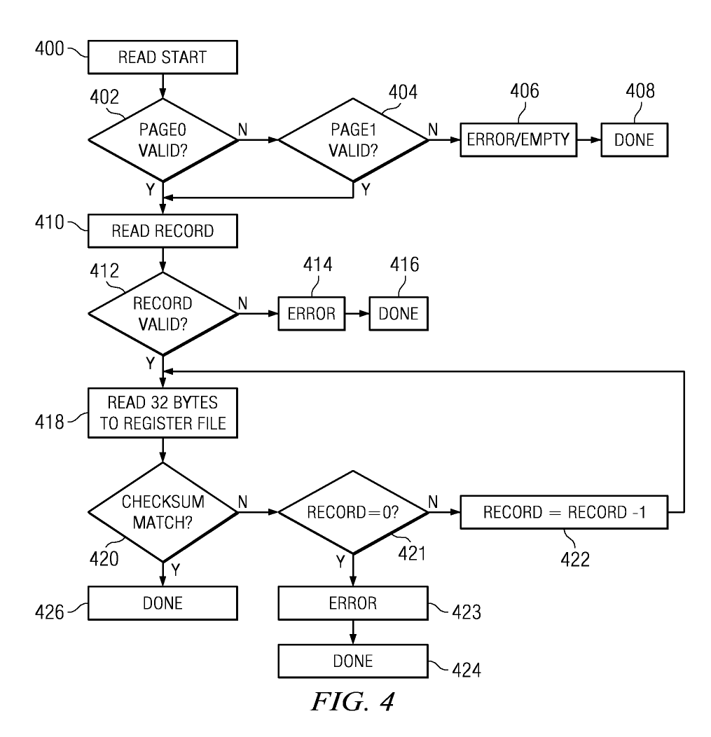

Referring now to the EEEPROM download flow chart of FIG. 4 and the block diagram of FIG. 3, the download (read) process for an exemplary EEEPROM is described.

At step 400 a EEEPROM Read process is started. The data bus 316, in some embodiments, receives an opcode such as EECNTL 206, which enables the EEEPROM 300 via the control logic circuitry 314. The EECNTL 206 may have the EEREAD 216 bit enabled instructing the control logic 314 that a Read is to take place. At steps 402 and 404 the control logic 314 reads the tag 308 of page0 302 and the tag of page1 304. If the page0 tag indicates that the page0 302 flash memory is the valid flash memory then the process advances to step 410. If however, page0 302 is not indicated as being the valid page then it is determined from either the page0 tag 308 or the page1 tag whether page1 is the valid flash memory page in step 404. If neither page0 nor page1 are valid then at step 406 an error code is provided indicating that there is either an error in the reading process or that the EEEPROM memory is empty. At step 408 the process stops due to the error or empty EEEPROM memory.

Going back to steps 402 and 404, once either page0 302 or page1 304 is determined to be the valid or active page, then the tag section or sector of the active page is interpreted at step 410 to determine a variety of information such as is there a valid or active data sector on the active page and which data sector 306 on the active page is the valid or active data sector. For example, page0 of FIG. 3 may be indicated as the active page, then the tag of page0 is interpreted to determine whether or not a data sector306 on page0 has been written thus indicating that there is a valid contained on the active page.

At step 412, it is determined from the page 0 tag 308 which data sector, if any, contains active data. If there are no active data on page0, then an error is provided at step 414 and the Read or download process is stopped at step 416. If at step 412 there is an active data sector on the active page then the indicated active data sector is read from the active sector in step 418 and provided to the RAM register file 312 via the data bus 322 to the RAM register file 312. Note that the address decode circuitry 326 may be considered, in some embodiments, as part of the control logic circuitry 314.

At step 420 the control logic circuit 314 compares the stored checksum from the page 0 tag 308 (the active page's tag sector) with a calculated checksum of the read 32-bytes of data in the RAM register 312 to determine whether the checksums match and indicate that the data was read from the active sector to the RAM register 312 correctly. If the checksums do not match, then at step 421 it is determined whether the sector read was from the “0” data sector 324. If the sector that was read was not the “0” data sector 324, then the active record or sector N 318 becomes equal to the active sector or record minus one or N−1 328, which points the address decode circuit 326 to the N−1 sector 328 such that the EEEPROM is searching for a previous most recent valid contents of the active page's memory sector at step 422. Returning back to step 418 the data stored in the N−1 328 sector is then read and placed via data bus 322, into the RAM register file 312. It is important to understand that in traditional EEPROM devices once the EEPROM memory is erased and rewritten with new active data, the old data (previous active data) that was stored in the traditional EEPROM memory is gone. As such, if a traditional EEPROM memory is read and does not pass a checksum comparison, then the device that the traditional EEPROM is being used in may lock up and become completely non-functional until proper data is provided or stored into the traditional EEPROM. Conversely, embodiments of the present invention when encountering a checksum comparison that does not match during a read of an exemplary EEEPROM can retrieve previously stored EEEPROM data that has a valid checksum. This new functionality may help minimize MCU malfunctions caused by prior art traditional EEPROM Read failures.

Returning to step 418 of FIG. 4, after the contents of the N−1 sector 328 is read into the register RAM 312, the checksum of the N−1 sector previously stored in the active page's tag (page0's tag 308) is compared with the newly calculated checksum of the data now stored in the register RAM 312. If that checksum does not match then the loop of steps 421 and 422 is continued until either the read and stored checksum match at step 420 or the record read is from the active page's 0 sector 324 wherein an error is produced at step 423 and the process ends at step 424.

If the checksum for the N−1 record 328 and the checksum stored in the active page's tag 308 match at step 420, then the process of reading the EEEPROM continues to completion of downloading the most recent valid EEEPROM contents from the active page to the RAM register at step 426.

Once the exemplary EEEPROM has downloaded the active or valid contents from the active page of the block-erasable memory to the RAM register 312 an MCU or other peripheral device may actively read the contents of the RAM register 312 via data bus 316, or other serial or parallel bus, each time the EEEPROM memory needs to be read.

Since one of the limitations of flash memory is that the flash memory locations cannot be erased one byte or word at a time, but instead must be erased a block at a time (normally at least a 64, 128, 256 or 512-byte blocks at a time), a technique for using flash memory in a manner that emulates traditional EEPROM's ability to be quickly written, then read and then erased and re-written was needed. In order to emulate a traditional EEPROM memory, embodiments of exemplary EEEPROM have design features that may include one or more of the following: (1) There are at least two pages of block-erasable memory set up in a Ping-Pong storage structure so that while newly active memory sectors of one page of block-erasable memory are being written and read, the other page or pages of block-erasable memory being erased; (2) Each page of block-erasable memory has a plurality of data sectors 306, each data sector has the same storage capacity as a RAM register 312; (3) When an exemplary EEEPROM emulates a traditional EEPROM's memory space that is being erased and then re-written, the address of the EEEPROM's active data sector is advanced to a next data sector (an N+1 data sector 330), which is then written. The N+1 data sector 330 becomes and is set as new active data sector and designated as the active data sector in the active page's tag sector. (4) When all the data sectors 306 of a first page (e.g., page0 302) of the active block-erasable memory page are written, another page (e.g., page2 304 ) will have been completely erased or reset and be ready to become the active page. And, (5) When the contents of an active page's active data sector is read from the active data sector, for example read to the RAM register 312, and a checksum error is encountered, then data in a previously active data sector of the active page can be read from the active page to, for example, the RAM register 312.

In an exemplary EEEPROM 300, an inactive flash memory page (i.e., a block-erasable memory page that is not the active page) is erased while the active flash memory page's data sectors are being written and read. In one embodiment of a EEEPROM, an inactive page of flash memory is completely erased after a predetermined data sector of the active flash memory page is written. This process may be referred to as upload with full erase. The predetermined data sector may be any one of the plurality of data sectors 306 in the active memory page. For example and referring to FIG. 3, assume page0 302 is the active memory page and includes M data sectors with each data sector being 32 byte s of memory space. Furthermore, assume that page1 304 is the inactive flash page memory also having M data sectors each with 32 byte s of memory space that have already been written. Then, each time the exemplary EEEPROM's RAM register 312 is written with data that is to be uploaded as emulated EEPROM data, the data to be uploaded is written from the RAM register 312 starting at page0's sector(0). Each time new data is to be written to as emulated EEPROM data, the active data sector address counter is incremented and each new data is written to the next active data sector (N+1) (e.g., sector (1), then sector(2) . . . , then sector(M)). When a predetermined data sector of page0 is written, for example when sector(M−1) 332 is written, then the control logic 314 provides a signal that instructs the entire inactive flash page, page(1) 304 to be erased, such that all the data sectors, and the tag sector of page1 304 are erased (not specifically shown). Then, after the Mth (last unwritten) data sector 334 of the active page0 memory is written and new data is to be written to the EEEPROM 300, since, all the available data sectors 306 have data in them, the logic control 314 will write to the tag of page1 304 setting page1 as the active and page0 as inactive. The next EEEPROM write will go to the first data sector (data sector 0) of the now active page1 memory 304.

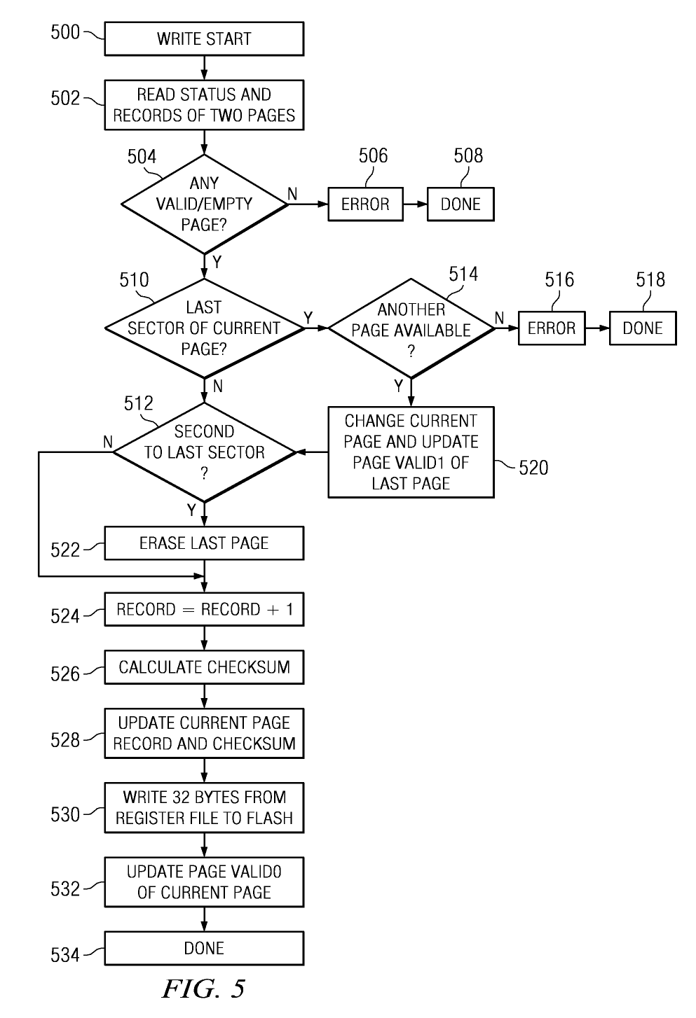

Referring now to FIG. 5, a flow chart is provided that further depicts an exemplary upload with a full erase process. At step 500, data intended for storage in the address space of a traditional EEPROM is loaded into a RAM register 312. The data may come from a special function register 320 via a data bus 316 or other peripheral circuit. In some embodiments, in order to load the data into the RAM register 312, a write enable instruction (EEEN 214 and EEWRT 218) is provided to the control logic 314 via an EECNTL 206 SFR. The data intended for storage in the EEEPROM 301 is provided by a data bus or via an SFR to the RAM register 312.

At step 502, the control logic 314 reads or determines the status of the two or more pages of flash memory to determine which page of flash memory is the active page to write. The control logic reads or determines which data sector or record location of the active flash memory page is the active data sector. Active page and active data sector information may be stored in a tag sector or record on each page of the flash or other type of block-erasable memory. In other embodiments the active page or active data sector may be stored in a register, SFR or other non-volatile or volatile memory space (not specifically shown).

At step 504, a determination is made as to whether any of the two or more flash memory pages are the active or valid page for writing new data. If none of the flash memory pages are determined to be active or valid by the control logic 314, then an error occurs at step 506 and the process ends at step 508. The device may require a reset instruction from bus 316 or a power-on reset to clear itself and operate properly again.

Back to step 504, if a page of memory is determined by the control logic 314 to be the active or valid page, then at step 510, the active page's tag or other memory register or location is read by the control logic 314 to determine which data sector 306 of the active page is the active or current data sector. The control logic 314 also determines whether the last data sector of the active page is the active data sector. Similarly, the control logic may, at step 510, determine if all the available data sectors of the active page have been written. If at step 510, it is determined that the active data sector of the active page is not the last sector of the current flash page that can be written, then the process advances to step 512.

Conversely, if at step 510, if the control logic 314 determines from the page tag sector (or other memory location) that the active data sector of the current active page is the last data sector that could have been written to on the current page, then at step 514, the control logic determines if another flash or block-erasable page is erased or reset and available to be written. If, for some reason, no other page is available to be written, then an error occurs at step 516 and the process is halted at step 518. In some embodiments a reset instruction or a power-on reset may be used to unlock the process and/or erase one or more flash memory pages.

If at step 514, it is determined by the control logic 314 that another flash memory page or block-erasable page of memory is available, erased of data, and ready to be written, then at step 520 the current active page is changed to indicate that the available, erased flash memory page is now the active page. This change of making the second or other flash memory page the new active or valid memory page is indicated in the tag section of at least the now active memory page and in some embodiments the tag section of all the flash memory pages or in a dedicated non-volatile memory or other register location.

At step 512 the control logic determines whether the active data sector of the active page memory is the next to last data sector that can be written on the active flash memory page. In other embodiments, the control logic determines whether the active data sector is a predetermined data sector of the active flash memory page. If the active data sector is the next to last data sector that can be written (or the predetermined data sector), then at step 522 the inactive flash memory page is completely erased. The inactive memory page is erased in anticipation of the active flash memory page having all the available data sectors being written and the exemplary EEEPROM needing an clean, erased data sector to upload (write) traditional EEPROM data for upcoming processes.

If at step 512, the next to last data sector is not the active data sector or, if the active data sector is not the predetermined data sector, then the address for the active data sector (or record) is advanced to a next unwritten data sector of the active page. In other words, the active sector is changed such that the active data sector becomes the next data sector in the active page at step 524.

At step 526, a checksum for the data in the RAM register 312 is calculated. In some embodiments, a dedicated check sum calculator 313 or general on-chip general purpose check sum calculator (not specifically shown) can be used for checking the validity of the data. And, at step 528, the active or current data sector number and the check sum are updated and/or stored in the active page's tag memory or another designated non-volatile or perhaps volatile memory space. At step 530, the data contents of the RAM register 312 is written to the active flash memory page's newly active data sector. In an exemplary embodiment, the control logic 314 provides the active page count 338 and active sector 336 count information to the address decode circuit 326.

After the newly active data sector is written, at step 532, the active page's tag sector or other designated memory space is updated as active and valid for the current active page. Finally at step 534, the uploading of data to the EEEPROM is complete such that the exemplary EEEPROM 300 is emulating the functionality of a traditional EEPROM by being read whenever an MCU's circuitry or other peripheral circuit requires the most recently stored information in the EEEPROM at power up, after temporary loss of power, or after a power-on reset. Furthermore, in some embodiments, an exemplary EEEPROM can provide the most recent previously stored data that was stored in the previously active data sector(s) of the active flash memory page, if the most recent active data sector is corrupted and produces an incorrect checksum when being read.

In yet another exemplary embodiment of an EEEPROM 300, an inactive flash memory page is similarly erased while the active flash memory page's data sectors are being written and read. But, in this embodiment of a EEEPROM, the contents of the inactive page of flash memory is partially erased after (or before) each data sector of the active flash memory page is written. This process may be referred to as upload with partial erase.

With respect to flash memory and other types of block-erasable memory, an example of what the term “partial erase” means is now provided using the workings of one type of flash memory being, for example, NOR flash. It is well understood that flash memory stores information in an array of memory cells made from floating-gate transistors. In traditional single-level cell (SLC) devices, each cell stores only one bit of information. Some newer flash memory, known as multi-level cell (MLC) devices, can store more than one bit per cell by choosing between multiple levels of electrical charge to apply to the floating gates of the cells. In, for example, NOR flash, each memory cell resembles a standard MOSFET, except the transistor has two gates instead of one. On top is a Control Gate (CG), as in other MOS transistors, but below this there is a Floating Gate (FG) insulated all around by an oxide layer. The FG is interposed between the CG and the MOSFET channel. Because the FG is electrically isolated by its insulting layer, any electrons placed on it are trapped there and under normal conditions will not discharge for many years. When the FG holds a charge, it screens (partially cancels) the electric field from the CG, which modifies the threshold voltage (Vt) of the cell. During read-out, a voltage is applied to the CG, and the MOSFET channel will become conducting or remain insulating, depending on the Vt of the cell, which in turn is controlled by the charge on the FG. The current flow through the MOSFET channel is sensed and forms a binary code, reproducing the stored data. In a multi-level cell device, which stores more than one bit per cell, the amount of current flow is sensed (rather than just its presence or absence), in order to determine more precisely the level of charge on the FG.

A single-level NOR flash cell in its default or erased state is logically equivalent to a binary “1” value, because current will flow through the channel under application of an appropriate voltage to the control gate. Generally, a NOR flash is programmed by setting selected memory cells to a binary “0” value and by leaving other memory cells with their default binary “1” value

It is important to also understand how, for example, NOR flash cells are erased (reset to the “1” state). Individual flash cells cannot be erased. Flash memory cells are erased in blocks, for example, of blocks of 64, 128, 256, or 512-bytes. It is faster to erase a block of flash memory cells, than it is to individually erase the same number of cells in a traditional EEPROM device. Conversely, it takes more time to erase a block of flash memory having a plurality of memory sectors, than it takes to erase a single sector of traditional EEPROM. To overcome the longer erase time of flash memory, embodiments of exemplary EEEPROM erase a page of flash memory while a different page is actively emulating the write and read functions of traditional EEPROM.

Unlike traditional EEPROM memory wherein individual bytes are erased one byte at a time as they are addressed, flash memory is erased in blocks of memory space by pulling electrons (charge) off the FGs of all flash memory cells in a block at the same time. The charge on the flash memory gates is removed through a process of quantum tunneling. Moreover, the entire charge on the FGs of a block of flash memory cells does not have to be removed or depleted in a continuous manner or all at the same time. In fact, in some embodiments, the process of erasing blocks of flash memory is performed by removing charge from the FGs of an inactive page of flash memory in a stepped or discontinuous manner. A stepped or discontinuous method of erasing a block of flash memory enables embodiments to partially erase a block of inactive flash memory each time a sector of active flash memory is written. By partially erasing a block of inactive flash memory each time one of the plurality of data sectors of an active flash memory page is written allows the necessary erase time needed to drain the FGs of the inactive flash memory to be divided by a number equal to or less than the number of writes to a predetermined number of data sectors in the active flash memory page. Each partial erase of an inactive page is additive to equal the amount of time required to erase a block of flash. By partially erasing an inactive page in an additive stepped manner, it is possible to completely erase the inactive page by the time the active page's data sectors have all been written. In yet other words, each time a data sector of the active page is written, the inactive page of block-erasable memory is partially erased such that the additive effect of each partial erase completely erases the inactive page by the time a last active data sector is written on the active page. An exemplary EEEPROM's inactive flash memory page can be completely erased and ready to be written at the same time or prior to the last data sector of the active flash memory page is being written. No additional wait time is necessary to erase or ensure that the inactive page of flash memory is completely reset or erased prior to changing the inactive page of flash memory the active page.

For example, in a two 512-byte page embodiment of an EEEPROM with partial erase, when the first sector, sector0, of the active page is being uploaded (written), 32-bytes of data may be written to a first sector, sector0, of the current active page. Then when each of next sectors, sector1 through sector 14, become the active data sector and are uploaded (written), two events occur: (1) 32-bytes of data are written to the active data sector of the active page; and (2) the inactive page (or pages) of flash memory are partially erased just before (or in some embodiments just after) the data is written to the active data sector of the currently active page of flash memory.

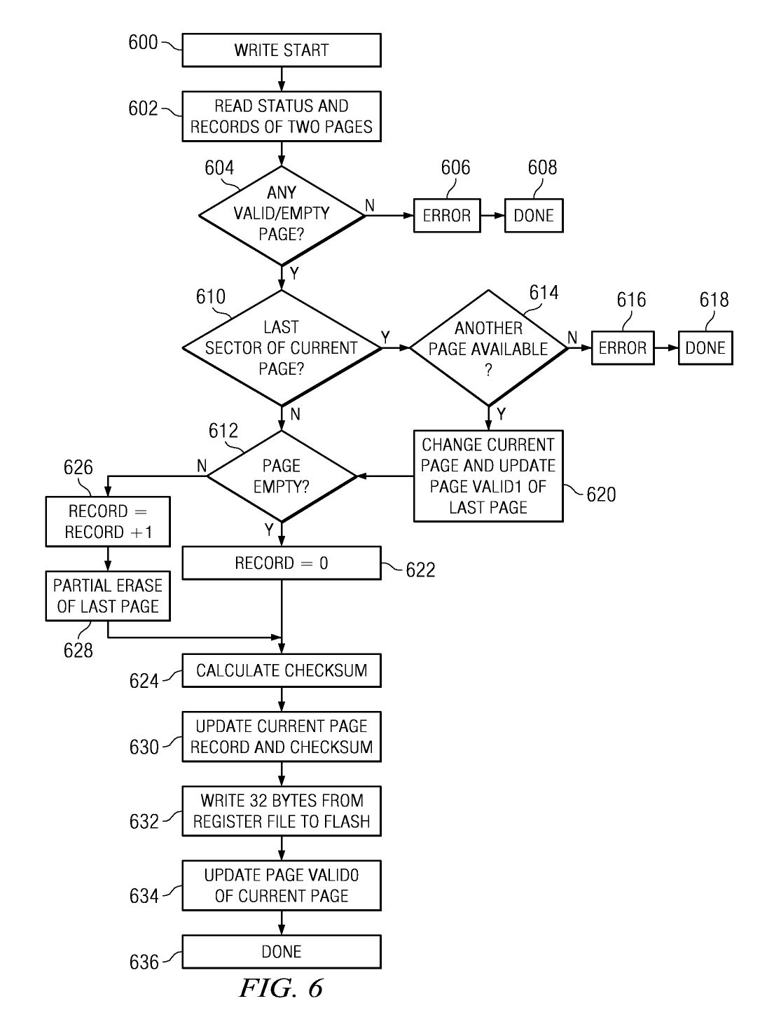

Referring now to FIG. 6, a flow chart is provided that depicts an exemplary upload with partial erase. At step 600, data intended for storage in a traditional EEPROM is loaded into the RAM register 312. The data may have come from a special function register 320 via a data bus 316 or from some other peripheral circuit. In some embodiments, the loading of data into the RAM register 312 requires a Write Enable instruction such as EEEN 214 and EEWRT 218. The Write Enable instruction may be provided to the control logic 314 via an EECNTL 206 SFR. The data intended for storage in an exemplary EEEPROM 301 may be provided by a data bus or via an SFR to the RAM register 312.

At step 602, the control logic 314 reads or determines the status of the two or more pages of flash memory 302, 304. The control logic circuitry 314 further obtains information from the tag sector or other memory register associated with each page of flash memory. The tag sector or other memory register contains data information about which page of the block-erasable memory is the active memory, which data sector of the active page is the active data sector and, in some embodiments, checksum data for each data sector of the active page that has been written. The tag sector or record location may be on each page of flash memory. In other embodiments, the active page and data sector information may be stored in a register or other non-volatile or volatile memory space (not specifically shown).

At step 604, a determination is made by the control logic 314 as to which one of the two or more flash memory pages is the active or valid page for writing data from the RAM register 312. In some circumstances, for example at an initial start-up, none of the pages have been written and thus, none of the pages are indicated as being the active page. If none of the pages are indicated as being an active page, step 604 determines whether any of the pages are empty and then selects an empty page to be the active and valid page. If the control logic 314 determines that none of the flash memory pages are set as the active page and none of the pages is considered empty, then an error occurs at step 606 and the upload process halts at step 608. An exemplary EEEPROM may require a reset instruction from bus 316 or other input not specifically shown to clear itself and operate properly again. In other embodiments, an exemplary EEEPROM may reset itself on a power-on reset or during start up.

Returning back to step 604, if a page is determined by the control logic 314 to be an active or valid page, then at step 610 the contents of active page's tag or other non-volatile memory location is read or reviewed by the control logic circuit 314 to determine which data sector 306 of the active page is presently the active or current data sector. The control logic 314 also determines whether a last data sector of the active page is also the active data sector. Similarly, the control logic may, at step 610, determine if all the available data sectors of the active page have been written. If at step 610, it is determined that the active data sector of the active page is not the last data sector that can be written in the active page, then the process advances to step 512. On the other hand, if at step 610, the control logic 314 determines from the information in the page tag sector (or other memory location) that the active data sector of the current active page is the last data sector that could have been written on the current page, then at step 614 the control logic 314 determines if another flash page is available to be written. If, for some reason, no other flash memory page is empty and available to be written, then an error occurs at step 616 and the process is halted at step 618. In some embodiments a reset instruction or a power on reset may be used to un-halt the process and/or erase one or more of the flash memory pages such that a flash memory page may be designated as the active page and be available for writing. If at step 614 the control logic 314 determines that another flash memory page is available by being erased of data, reset and ready to be written, then at step 620 the current valid page is changed from the current valid page to the available, reset and erased flash memory page. The new available reset and erased flash memory page becomes the new active or valid flash memory page and the tag sector of, at least, this new active flash memory page is updated to indicate its new status as active. In some embodiments the tag sector of all the flash memory pages or a dedicated non-volatile memory or register location is updated to indicate that a different flash memory page is now the active flash memory page.

At step 612 the control logic 314 determines whether the active page memory has already been written to or is empty. In some embodiments determining whether the active page is empty may be accomplished by determining whether data sector0 has been written or by checking the tag sector of the active page to determine if any sector of the active page has been written or verified if the checksum of the tag matches the checksum calculated with the associated data sector. If it is determined that the active page is newly active and/or its data sectors are all empty or unwritten then at step 622 the sector or record counter is set to zero. At step 624 the contents for the RAM register 312 is read by the address decode 326 and a checksum for the data in the RAM register 312 is calculated at step 624.

Referring back to step 612 wherein the active page is determined to be empty or not, if it is determined that the active page's data sectors are not empty or have at least one data sector written to then at step 626 the record sector counter is advanced by one. At step 628 the inactive page is partially erased by partially draining the floating gates of the plurality of flash memory cells therein.

Again at step 624 the checksum for the data within the RAM register 312 is calculated by either the address decode circuitry 326 or the control logic circuitry 314 or a dedicated checksum calculator on chip (not specifically shown).

At step 630, the active or current data sector number and the checksum for the newly active data sector are updated and/or stored in the active pag's tag memory sector or other designated non-volatile memory space. At step 632, the data contents of the RAM register 312 is written to the active flash memory pages active data sector where it is stored in a non-volatile manner. The control logic 314 may have provided the address code circuitry 326 the proper sector number and the proper active page number such that the contents of the RAM register 312 is stored in the proper memory space of the flash memory. The process of determining which page is the active page, which data sector is the active data sector and determining the address of the active data sector may be referred to as mapping and writing data to the active data sector of the active page.

After the now active data sector is written, then the active pages tag sector, or other designated non-volatile memory space, is updated to indicate which page of the flash memory is the active and valid page. Finally, at step 636, the uploading of new data to the EEEPROM is complete such that an exemplary EEEPROM 300 can actively emulate the functionality of a traditional EEPROM.

One advantage of embodiments of an exemplary EEEPROM over a traditional EEPROM is easily understood when considering the negative ramifications of encountering a power failure or power-on reset that occurs during an erase and program phase of a traditional EEPROM. In a traditional EEPROM, if a power failure occurs during the erase and program phase, the data that was contained in the EEPROM may have been erased and the new data that was to be written into the traditional EEPROM may not have been completely stored or have been invalidly stored into the traditional EEPROM. Conversely, an advantage of an exemplary EEEPROM that encounters a power failure or power on reset during a similar write or program phase is that although the data that was being written or programmed into the newly active sector may be lost, the most recent previous (i.e., the last successfully written) data that was programmed into the previous active sector (whether on the same page or the previously active page of memory) is still available for being read by the RAM register 312 (or other register) and provided to, for example, the MCU or another peripheral circuit. This advantage is easily accomplished because the active page, active record and the checksum for each previously written or programmed data sector is stored in the tag sector of the active flash memory page. This particular advantage was discussed above in the discussion of FIG. 4 at or around step 422.

One concern that exists for both traditional EEPROM and exemplary EEEPROM devices or circuits occurs when a power failure is encountered during a data upload into the traditional EEPROM's memory space or an exemplary EEEPROM active page memory. Many systems, circuit cards, and even MCUs are adapted to provide some limited amount of power to perform a limited number of tasks when a power failure occurs without notice. In the exemplary EEEPROM, data in the RAM register file can be uploaded to and active data sector in flash when an unexpected power failure is encountered. For example, in an embodiment comprising a 32-byte RAM register along with 32-byte data sectors in the active flash memory page embodiments have a best case upload from RAM register to data sector flash memory for 32 byte s of uploading to the data sector of a total of only ten cycles for performing all of the steps of page and sector decoding along with 34 writes. The 34 writes are needed to write the 32 byte s of data into the active data sector plus a write to store the active data sector number and another write to store the checksum of the active data sector. A worst case scenario for the amount of time it would take to store data from the RAM register 312 into the active data sector when a power failure is indicated would be the situation of the full erase embodiment wherein the power failure occurs at the same time that the full page erase is required. Thus for the worst case, the amount of time required for uploading data from the RAM register 312 to the active data sector would be equal to the amount of time necessary to perform a full page erase plus 32 byte s of uploading the contents of the RAM register data sector which would be functionally equal to 10 cycles of decoding, 34 writes, plus one page erase. It is estimated that a normal amount of time and energy necessary to upload data from a RAM register file to the active data sector upon a power failure can be calculated based on a partial erase embodiment of the exemplary EEEPROM. Thus, a normal case for a partial erase embodiment would require enough time to perform a partial erase on the inactive flash page memory plus 32 byte s of uploading which equals 10 cycles for decoding, 34 writes and the time required for 1/14 of a page erase plus ramp-up and ramp down time.

To get a better feeling for the amount of charge required to perform a power failure upload the following information is provided. An exemplary flash memory may require 26 microseconds to program. The same flash memory, if it is 512 bytes per page, has page erase time of about 25 milliseconds plus about 200 microseconds to ramp-up plus about 20 microseconds to ramp down. The same page of flash memory can perform a partial erase in about 25 microseconds divided by the number of data sectors plus about 200 microseconds to ramp-up plus about 200 microseconds to ramp down for each partial erase. If the flash memory is operating at a voltage between about 1.65 and 1.95 volts DC then a IDDREAD requires about 10 milliamps maximum and an IDDWRITE/ERASE requires about 9 milliamps maximum thus the stored charge required for the best case of uploading data from a data register file to an active data sector in the flash memory is about 8 μC. The charge needed for the worse case (full page erase case) for uploading data from the RAM register to the active data sector would be about 235 μC and, the charge needed for a normal situation wherein power is interrupted while the RAM register is loading data into the active flash memory data sector and it is the partial erase situation where the number of data sectors equals 14 will require about 26 μC of stored charge to upload the data. Based on calculations, about 173 μF capacitance would be required on or near the device to store enough charge to provide the charge needed to perform the steps required to store RAM register data to an active data sector of flash memory upon a power failure during an upload process.

Referring back to FIG. 3, it is noted that in yet another embodiment of the invention a plurality of flash memory pages may be used in exemplary embodiments of an EEEPROM. In particular, in addition to page0 302 and page1 304, additional pages including page2 340 may be incorporated such that while data sectors of an active page, for example page0 302, are being written and read, one or more of the inactive pages, page1 304 or page2 340, etc., may be incrementally erased each time a write (uploading) process is performed on the active page (page0 302).

It will be appreciated by those skilled in the art having the benefit of this disclosure that an exemplary EEEPROM provides a competitive alternative to traditional EEPROM devices by using at least two pages of block-erasable memory that are configured in a ping-pong storage structure such that while one page of the block-erasable memory is being written and/or read, another page of block-erasable memory is being either fully or partially erased. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method of writing to and reading data from a circuit comprising control logic circuitry, a first block-erasable memory page and a second block-erasable memory page, the method comprising:
a first writing of a predetermined number of data bytes to a first address space;
a first mapping and writing, by the control logic circuitry, of the predetermined number of data bytes to an active data sector, the active data sector being the next data sector of a plurality of data sectors in the first block-erasable memory page, the first block-erasable memory page comprising a first memory space being a multiple of the predetermined number of data bytes;
repeating the first writing and the first mapping and writing until a last data sector of the plurality of data sectors in the first block-erasable memory page is written;
erasing the second block-erasable memory page during at least one repeated first mapping and writing;
a second writing of the predetermined number of data bytes to the first address space;
a second mapping and writing, by the control logic circuitry, of the predetermined number of data bytes to the active data sector, the active data sector being the next data sector of a plurality of data sectors in the second block-erasable memory page, the second block-erasable memory page comprising a second memory space being the multiple of the predetermined number of data bytes, the second mapping and writing occurring after the last data sector of the plurality of data sectors in the first block-erasable memory page is written;
repeating the second writing and the second mapping and writing until a last data sector of the plurality of data sectors in the second block-erasable memory page is written; and
erasing the first block-erasable memory page during at least one repeated second mapping and writing.

2. The method of claim 1, further comprising:
requesting that the active data sector be read from the first address space;
first determining, by the control logic circuitry, whether the first block-erasable memory page or the second block-erasable memory page is a valid page comprising the active data sector;
second determining, by the control logic circuitry, which data sector of the valid page is the active data sector;
reading the active data sector of the valid page to the first address space.

3. The method of claim 1, wherein the erasing the second block-erasable memory page during at least one of the first mappings and erasings further comprises fully erasing the second block-erasable memory page after a predetermined first mapping and writing.

4. The method of claim 1, wherein the erasing the second block-erasable memory page during at least one of the first mappings and writings further comprises partially erasing the second block-erasable memory page after each one of a plurality of first mappings and writings.

5. The method of claim 1, wherein the first block-erasable memory further comprises a first tag sector such that the tag sector stores a valid page information, an active data sector information, and checksum information.

6. The method of claim 5, wherein each first mapping and writing further comprises updating the first tag sector such that the active data sector is equal to the next data sector of the plurality of data sectors in the first block-erasable memory page.

7. The method of claim 5, wherein each first mapping and writing further comprises updating the first tag sector such that the checksum information comprises a checksum for the predetermined number of data bytes.

8. The method of claim 2, wherein the first block-erasable memory page further comprises a first tag sector such that the first tag sector stores a valid page information, an active data sector information and checksum information;
wherein the first determining further comprises interpreting a read of the contents of the first tag sector to determine the valid page; and
wherein the second determining further comprise interpreting the read of the contents of the first tag sector to determine the active data sector of the valid page.

9. The method of claim 1, wherein the first block-erasable memory page and the second block erasable memory page are flash memory.

10. A method of reading data from and writing data to a block-erasable memory comprising a plurality of pages and a control logic circuit,
the method of reading data from the block-erasable memory comprising:
receiving, by the control logic circuit, a read request;
determining, by the control logic circuit, an active page of the plurality of pages;
determining, the control logic circuit, an active sector of the active page;
reading active data from the active sector of the active page to a register, the active data read to the register being output data; and
making the output data valid data and available to a peripheral circuit; and
the method of writing data to the block-erasable memory comprising:
determining, by the control logic circuit, the active page of the plurality of pages, each one of the plurality of pages having a plurality of data sectors;
determining, by the control logic circuit, the active data sector of the plurality of data sectors of the active page;
if the active data sector is not the last data sector of active page, then changing the active data sector to be a next data sector of the plurality of data sectors of the active page;
if the active data sector is the last data sector of the active page, then changing the active page to a next page of the plurality of pages and changing the active data sector to a first data sector of the active page;
if the first data sector of the active page is not the active data sector, then erasing at least a partial amount of at least one page of the plurality of pages, the at least one page not being the active page; and
writing register data to the active data sector of the active page.

11. The method of claim 10, wherein erasing at least a partial amount comprises fully erasing at least one page of the plurality of pages if the active sector is a predetermined data sector of the active page.

12. The method of claim 10, further comprising a tag memory space, the tag memory space comprising status information, the status information comprising active page data, active sector data, and checksum data.

13. A method of emulating a traditional EEPROM in a device comprising a plurality of pages of block-erasable memory and a control logic circuit, the method of emulating comprising a method of writing to an active data sector of one of the plurality of pages of block-erasable memory and a method of reading from the active data sector of one of the plurality pages of block-erasable memory;
the method of writing comprising:
first interpreting, by the control logic circuit, from a first contents of a first tag data associated with a first block-erasable memory page and from a second contents of a second tag data associated with a second block-erasable memory page, whether the first block-erasable memory page or the second block-erasable memory page is an active page;
if the first block-erasable memory page is the active page, then interpreting, by the control logic circuit, from the first contents an active data sector;
if the second block-erasable memory page is the active page, then interpreting, by the control logic circuit, from the second contents the active data sector;
second interpreting, by the control logic circuit, whether the active data sector is a last data sector of the active page;
if the active data sector of the active page is not the last data sector, then advancing the active data sector such that the active data sector becomes equal to a next data sector of the active page, the active page having a predetermined number of data sectors;
erasing at least a partial amount of a block-erasable memory page that is not the active page;
calculating a checksum for a register data received from a peripheral circuit, the register data being a predetermined number of bytes;
updating the first contents if the active page is the first block-erasable memory page or updating the second contents if the active page is the second block erasable memory page such that the updated first or second contents comprises an indication of the advanced active data sector and the checksum, the checksum being considered an active data checksum for the active data sector; and
writing the register data to the active data sector, the register data being active data when in the active data sector.

14. The method of claim 13, wherein if the second interpreting determines that the active data sector is the last data sector, then designating a different one of the plurality of pages of block-erasable memory as the active page.

15. The method of claim 14, wherein designating a different one of the plurality of pages of block erasable memory as the active page comprises:
changing, if the active page is the second block-erasable memory page, the active page to the first block-erasable memory page as the active page and setting a first data sector of the first block-erasable memory page as the active sector; and
changing, if the active page is the first block-erasable memory page, the active page to the second block-erasable memory page as the active page and setting a first data sector of the second block-erasable memory page as the active sector.

16. The method of claim 15, wherein after designating, further comprising:
updating the first contents, if the active page was changed to the first block-erasable memory page, to indicate that the first block-erasable memory page is now the active memory page and that the first data sector of the first block-erasable memory page is the active sector; and
updating the second contents, if the active page was changed to the second block-erasable memory page, to indicate that the first page is now the active page and that the first data sector of the second block-erasable memory page is the active sector.

17. The method of claim 13, wherein the plurality pages of block-erasable memory are flash memory.

18. The method of claim 13, wherein the method of reading further comprises:
receiving, by the control logic circuit, a read request;
third interpreting, by the control logic circuit using the first contents and the second contents, whether the first block-erasable memory page or the second block-erasable memory page is the active page;
if the first block erasable memory page is the active page, then interpreting, by the control logic circuit, from the first contents the active data sector;
if the second block-erasable memory page is the active page, then interpreting, by the control logic circuit, from the second contents the active data sector;
reading active data from the active data sector to a register, the active data read to the register being output data;
calculating an output data checksum for the output data;
first comparing whether the active data checksum and the output data checksum match; and
if the output data checksum and the active data checksum match, then indicating that the output data in the register is valid data.

19. The method of claim 18, wherein if the output data checksum and the active data checksum do not match, then decreasing the active data sector such that the active data sector is not equal to a previous active data sector and returning to and performing the reading active data from the active data sector to the register step.

20. The method of claim 13, wherein erasing further comprises erasing the block-erasable memory page that is not the active page when the active data sector is a predetermined sector.

21. The method of claim 13, wherein erasing further comprises partially erasing the block-erasable memory page that is not the active memory page each time one data sector of the predetermined number of data sectors is written.
